(19) United States
(12) Patent Application Publication
(10) Pub. No.: US 2026/0311986 A1
(43) Pub. Date: Oct. 8, 2026

(54) METHOD AND APPARATUS

(71) Applicant: BRUKER SWITZERLAND AG, Fällanden (CH)

(72) Inventors: Ben Jones, Manning Park, MA (US); Mark Ridgeway, Manning Park, MA (US)

(73) Assignee: BRUKER SWITZERLAND AG, Fällanden (CH)

(21) Appl. No.: 19/170,658

(22) Filed: Apr. 4, 2025

(51) Int. Cl. H01J 49/06; H01J 49/40

(52) U.S. Cl. CPC H01J 49/062; H01J 49/067; H01J 49/401

(57) ABSTRACT

An ion guide assembly has a first ion guide having an entrance and an exit, a set of electrodes including a terminal lens-electrode disposed adjacent to the exit of the first ion guide, a power supply configured to supply voltages to the set of electrodes, and a controller configured to control the power supply to supply a voltage, for example an AC voltage, to the terminal lens-electrode to regulate exiting of ions from the exit of the first ion guide. The controller is further configured to control parameters of the voltage supplied by the power supply to the terminal lens-electrode to determine respective exit times of the ions exiting from the exit of the first ion guide.

### BACKGROUND

### Field

The present invention relates to ion guide assemblies for mass spectrometry, such as time-of-flight mass spectrometry, and particularly to linear radio-frequency ion guides and collision cells for use with time-of-flight mass spectrometers.

### Background Information

Time-of-flight (TOF) mass analyzers separate ions based on their mass-to-charge (m/z) ratio. In contrast to quadrupole mass filters where a mass spectrum is generated by scanning parameters to selectively transport ions across a narrow mass range, TOF analyzers provide a panoramic view over the entire mass spectrum in the microsecond time scale.

The orthogonal TOF configuration was developed specifically for sampling continuous or quasi-continuous ion beams, while radio-frequency (RF) linear ion guides are typically used for transferring ions to the extraction region, also known as the orthogonal acceleration region of the TOF. In addition, linear RF ion guides can be operated as collision cells by providing a collision gas along the ion path to collisionally activate ions and to generate fragments, which are subsequently analyzed by TOF. RF ion guides directly coupled to orthogonal TOF analyzers and operated at elevated pressure are also used for ion thermalization and phase space compression to enhance mass resolving power. Generally, combining RF ion guides supplied with a buffer gas and orthogonal TOF is a convenient way of generating and delivering a collimated beam of ions to the TOF analyzer for high resolution mass measurements.

The duty cycle of the orthogonal TOF is typically <30% when a continuous beam is sampled at the highest possible repetition rate determined by the Iongest ion flight time. Methods to improve the sampling efficiency by trapping and subsequent timed release of the ions have been developed, which can improve duty cycle but only for a narrow mass range.

An alternative approach has been presented to improve the duty cycle of the oTOF over a wide mass range and this includes the formation of an axial mass-dependent pseudopotential well created by an additional alternating current (AC) voltage. The AC voltage can be superimposed to the RF voltage applied to the pole-electrodes of the linear ion guide or applied to the terminal lens-electrode of the RF ion guide. By ramping down the AC voltage, ions can be released from the RF ion guide sequentially from high to low m/z, while all ions are gaining the same axial kinetic energy. Upon entering the pulsed extraction region of the TOF, ions with lower m/z catch up with heavier ions, and the AC ramp parameters can be selected to make all ions meet in the center of the TOF extraction region, enhancing sampling efficiency and instrument duty cycle without loss of mass accuracy or resolution. (J Am Soc Mass Spectrom 2009, 20, 1342-1348). FIG. 1 schematically depicts a conventional apparatus (EP1743354B1) comprising an RF ion guide 34 with an exit-end 42 having an exit lens-electrode, the terminal lens electrode, 46 and an additional electrostatic lens 26 for collimating ions into the oTOF pulse extraction region 56.

The two basic modes of operation in the AC extraction method have been tested (J Am Soc Mass Spectrom 2009, 20, 1342-1348), and it was found experimentally that the second mode where the AC voltage is applied to the terminal lens electrode 46 is the simplest, since there is no need to apply all the RF, AC and DC voltages superimposed to the same electrodes. In addition, applying the AC voltage to the pole-electrodes of the RF ion guide 34 would prevent continuously injecting ions into the RF ion guide, as a pseudo potential barrier would be established at the entrance. Nevertheless, it was also reported that mass accuracy and TOF mass resolving power are reduced, while the enhancement in the duty cycle was also less compared to the first mode where the AC voltage was superimposed to the RF pole-electrodes.

### SUMMARY

A first aspect provides an ion guide assembly, comprising:
a first ion guide, having an entrance and an exit;
a set of electrodes, including a terminal lens-electrode disposed adjacent to the exit of the first ion guide;
a power supply, configured to supply voltages to the set of electrodes; and
a controller, configured to control the power supply to supply a voltage, for example an AC voltage, to the terminal lens-electrode to regulate exiting of ions from the exit of the first ion guide;
characterized by:
wherein the controller is configured to control parameters of the voltage supplied by the power supply to the terminal lens-electrode to determine respective exit times of the ions exiting from the exit of the first ion guide.

A second aspect provides a method of guiding ions, the method comprising:
guiding ions in a first ion guide, having an entrance and an exit; and
regulating exiting of ions from the exit of the first ion guide by controlling supply of a voltage, for example an AC voltage, to a terminal lens-electrode disposed adjacent to the exit of the first ion guide; characterized by:
controlling parameters of the voltage supplied to the terminal lens-electrode to determine respective exit times of the ions exiting from the exit of the first ion guide.

A third aspect provides an assembly for mass spectrometry, comprising:
an ion mobility separation device configured to separate ions based on mobility;
a radio frequency ion guide for receiving the ion mobility separated ions through an entrance end, holding the ion mobility separated ions within and outputting the ion mobility separated ions through an exit end;
a terminal lens-electrode located at the exit end of the radio frequency ion guide, being connected to a power source for, during a first phase of operation, receiving at least one voltage which keeps the ion mobility separated ions from exiting the radio frequency ion guide through the exit end and, during a second phase of operation, changing the at least one voltage received by the terminal lens-electrode so as to allow the ion mobility separated ions of a selected mass to charge ratios m/z to exit the radio frequency ion guide through the exit end sequentially;
an ion optical assembly located downstream of the terminal lens-electrode for guiding the ion mobility separated ions of the selected mass to charge ratios m/z exiting the radio frequency ion guide;
a screening lens-electrode located between the terminal lens-electrode and the ion optical assembly for substantially screening the ion optical assembly from the at least one voltage applied to the terminal lens-electrode;
an interface coupled to an orthogonal mass analyzer located downstream from the ion optical assembly for receiving the ion mobility separated ions of the selected mass to charge ratios m/z exiting from the radio frequency ion guide;
a control system communicating with the terminal lens-electrode and the interface and being designed and configured such that the changing the at least one voltage is executed such that substantially all the ion mobility separated ions of a selected mass to charge ratio m/z exiting from the radio frequency ion guide are out-pulsed therefrom at substantially the same time into the orthogonal mass analyzer.

A fourth aspect provides a method of mass spectrometry, comprising:
separating ions based on mobility;
receiving the ion mobility separated ions through an entrance end in a radio frequency ion guide, holding the ion mobility separated ions within the radio frequency ion guide and outputting the ion mobility separated ions through an exit end of the radio frequency ion guide, comprising: during a first phase of operation, receiving at least one voltage, at a terminal lens-electrode located at the exit end of the radio frequency ion guide, which keeps the ion mobility separated ions from exiting the radio frequency ion guide through the exit end; and during a second phase of operation, changing the at least one voltage received by the terminal lens-electrode so as to allow the ion mobility separated ions of selected mass to charge ratios m/z to exit the radio frequency ion guide through the exit end sequentially;
guiding the ion mobility separated ions of the selected mass to charge ratios m/z exiting the radio frequency ion guide in an ion optical assembly located downstream of the terminal lens-electrode;
substantially screening the ion optical assembly from the at least one voltage applied to the terminal lens-electrode using a screening lens-electrode located between the terminal lens-electrode and the ion optical assembly;
receiving the ion mobility separated ions of the selected mass to charge ratios m/z exiting from the radio frequency ion guide in an interface coupled to an orthogonal mass analyzer located downstream from the ion optical assembly; and
controlling the terminal lens-electrode and the interface such that the changing the at least one voltage is executed such that substantially all the ion mobility separated ions of a selected mass to charge ratio m/z exiting from the radio frequency ion guide are out-pulsed therefrom at substantially the same time into the orthogonal mass analyzer.

A fifth aspect provides a mass spectrometer comprising an ion guide assembly according to the first aspect; and/or an assembly according to the third aspect.

A sixth aspect provides a method of guiding ions according to the second aspect; and/or a method of mass spectrometry according to the third aspect.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a conventional apparatus;

FIG. 2A schematically depicts a conventional apparatus, and FIG. 2B schematically depicts an apparatus according to an exemplary embodiment;

FIG. 3 is a graph of intensity versus axial position in orthogonal accelerator for a conventional method;

FIG. 4 is a graph of intensity versus axial position in orthogonal accelerator for a method according to an exemplary embodiment;

FIGS. 5A to 5D are graphs of intensity versus axial position in orthogonal accelerator for a method according to an exemplary embodiment: FIG. 5A: 1.2 1/K0; FIG. 5B: 1.0 1/K0; FIG. 5C: 0.8 1/K0; and FIG. 5D: 0.6 1/K0;

FIG. 6 is a graph of intensity versus m/z for a method for a conventional method: a normal tune mix distribution, using standard collision cell operation (2000 Vpp 10 μsec prepulse 120 μsec transfer);

FIGS. 7A to 7B are graphs of intensity versus m/z for a method according to an exemplary embodiment: FIG. 7A: using a 60 μsec delay and a scan of 70 μsec (8 V/usec), the m/z range is reduced but intensity for transmitted species increased; and FIG. 7B: using a 92 μsec delay and scan time 35 μsec (16 V/usec), the m/z bandwidth is further reduced with signal increasing for the transmitted range;

FIG. 8 is a plot of mobility versus m/z for a method according to an exemplary embodiment, showing moving survey scan targeted enhancement area;

FIG. 9 is a plot of mobility versus m/z for a method according to an exemplary embodiment, showing moving fragment scan targeted enhancement area;

FIG. 10 is a graph of intensity versus mobility of ions for (a) a conventional method (solid line); and (b) a method according to an exemplary embodiment (dashed line);

FIG. 11 schematically depicts a method according to an exemplary embodiment;

FIGS. 12A to 12C schematically depict a method according to an exemplary embodiment; and

FIG. 13 schematically depicts a method according to an exemplary embodiment.

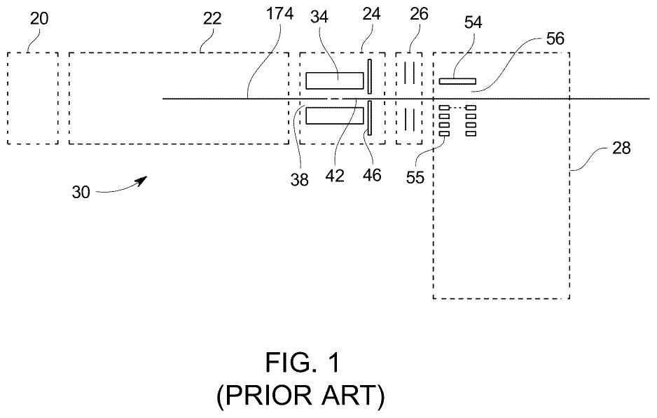

### DETAILED DESCRIPTION

By applying an RF voltage to the terminal lens-electrode of an ion guide (for example, a collision cell), a pseudopotential barrier is formed. By ramping this RF voltage down in time, ions are released from high to low mass m/z in order. This enables the larger or heavier (i.e. slower) ions to be efficiently transported to an orthogonal accelerator in an interface, for example, at the same time as the smaller or lighter (i.e. faster) ions, which are released later from the first ion guide. Sensitivity may be further optimized by adjusting the applied RF voltage amplitude, ramp, and delay parameters to optimize further for a given mass to charge ratio m/z range. In timsTOF, for example, a known mass mobility distribution exists enabling further optimization of the applied RF voltage by synchronizing with the mobility ramp as only a given mass to charge ratio m/z range will be present for a given mobility. This can also be applied in MS/MS workflows even though the correlation between mobility and fragment mass is relatively weaker. Nevertheless, in such MS/MS workflows, optimization may be made by narrowing the target mass to charge ratio m/z range.

In more detail, a RF pseudopotential barrier may be used to mass selectively eject ions from an ion guide (for example, a collision cell), with the ideal case being all ions simultaneously reaching the center of the TOF accelerator (also known as pusher) at exactly the same time and therefore providing a very broad mass to charge ratio m/z bandwidth. In practice, this is not exactly the waveform parameters which allow a broad mass range sacrifice intensity similar to the previous trade off known of collision cell timings. When used in combination with TIMS (or other ion mobility techniques), there is a known correlation between mass to charge ratio m/z and ion mobility, so one can have a narrow mass range for maximum sensitivity while changing the narrow mass range as a function of mobility to address the entire mass range. The correlation between mass and mobility is relatively weaker for MS/MS but still correlated and can still benefit. For targeted product reaction monitoring (PRM), the correlation between mass and mobility is also known and can therefore be used to optimize sensitivity for selected ions.

Generally, there are two parameters of particular interest for pseudopotential barrier type ion guide operation: scan (or ramp) rate in V/s (typically V/μs) and a delay between the start of that ramp (for example, from high voltage to low voltage) and the TOF trigger (i.e. the ramp start time, either absolute or relative to the TOF trigger). The ramp rate to some extent determines the mass to charge ratio m/z bandwidth, with relatively lower ramp rates providing relatively broader mass to charge ratio m/z ranges to be time focused in the TOF accelerator and relatively higher ramp rates providing relatively narrower mass to charge ratio m/z ranges to be time focused in the TOF accelerator. Relatively narrower mass to charge ratio m/z ranges time focused in the TOF accelerator result in relatively improved sensitivities (intensities). The delay for a given ramp determines to some extent what mass to charge ratio m/z ions are present in the TOF accelerator when its energized.

In one example, for survey (MS1) scans with mobility, the ramp) rate is relatively high (creating a relatively narrow mass distribution of high intensity) with the delay time correlated to mobility. In one example, for MS2 scans, the ramp rate is relatively lower with a possible different delay correlation to mobility. In one example, for target analysis, ramp rate and/or delay may be functions of the target list and calculated according to a list of product ions which are scheduled according to their respective retention times, mobilities, and/or precursor masses.

### Ion Guide Assembly

The first aspect provides an ion guide assembly, comprising:
a first ion guide, having an entrance and an exit;
a set of electrodes, including a terminal lens-electrode disposed adjacent to the exit of the first ion guide;
a power supply, configured to supply voltages to the set of electrodes; and
a controller, configured to control the power supply to supply a voltage, for example an AC voltage, to the terminal lens-electrode to regulate exiting of ions from the exit of the first ion guide;
characterized by:
wherein the controller is configured to control parameters of the voltage supplied by the power supply to the terminal lens-electrode to determine respective exit times of the ions exiting from the exit of the first ion guide.

### Ion Guide

The ion guide assembly comprises the first ion guide (also known as a radio frequency ion guide), having the entrance and the exit.

In one example, the first ion guide comprises and/or is a multipole ion guide and/or a stacked ring ion guide.

In one example, the first ion guide comprises and/or is a collision induced dissociation (CID) cell (also known as a collision cell).

### Set of Electrodes

The ion guide assembly comprises the set of electrodes, including a terminal lens-electrode disposed adjacent to the exit of the first ion guide.

In one example, the terminal lens-electrode comprises and/or is: a ring electrode, an apertured plate and/or a skimmer-shaped lens-electrode having an aperture therethrough.

### Power Supply

The ion guide assembly comprises the power supply, configured to supply voltages to the set of electrodes. Suitable power supplies are known.

### Controller

The ion guide assembly comprises the controller, configured to control the power supply to supply the voltage, for example an AC voltage, to the terminal lens-electrode to regulate exiting of ions from the exit of the first ion guide. Suitable controllers are known.

The controller is configured to control parameters of the voltage supplied by the power supply to the terminal lens-electrode to determine respective exit times of the ions exiting from the exit of the first ion guide.

Additionally and/or alternatively, the controller is configured to control parameters of the voltage supplied by the power supply to the terminal lens-electrode to determine respective positions of the ions exiting from the exit of the first ion guide at a predetermined time, wherein the respective positions of the ions are beyond the exit of the first ion guide.

Additionally and/or alternatively, the controller is configured to control parameters of the voltage supplied by the power supply to the terminal lens-electrode to determine respective times of the ions exiting from the exit of the first ion guide at a predetermined position, wherein the predetermined position is beyond the exit of the first ion guide.

In one example, the controller is configured to control ramp parameters of the voltage.

In one example, the controller is configured to control ramp amplitude, ramp duration, ramp start time, ramp end time, ramp rate, ramp shape (for example, linear or non-linear) and/or ramp direction (i.e. down or up). In one example, the ramp start time and/or the ramp end time is/are absolute times or relative to a TOF trigger, such as for a pusher for an orthogonal acceleration assembly of a TOF mass analyzer. In one example, the controller is configured to control the ramp parameters, for example a delay, the ramp start time and/or the ramp end time synchronously with a TOF trigger.

In one example, the controller is configured to control ramp rate and/or a delay between a start of the ramp and a TOF trigger (i.e. the ramp start time, either absolute or relative to the TOF trigger).

In one example, the ramp parameters are selected from a group consisting of ramp amplitude, ramp duration, ramp start time, ramp end time, ramp rate, ramp shape and/or ramp direction.

In one example, the controller is configured to dynamically control parameters of the voltage supplied by the power supply to the terminal lens-electrode, for example for the respective ions, such as according to the respective mass to charge ratios m/z and/or ion mobilities thereof. In one example, the controller is configured to dynamically control parameters of the voltage supplied by the power supply to the terminal lens-electrode based on a list of target ions, for example obtained thereby.

In one example, the controller is configured to control ramp parameters of the voltage, such as according to the respective mass to charge ratios m/z and/or ion mobilities thereof. In one example, the controller is configured to dynamically control ramp parameters of the voltage based on a list of target ions, for example obtained thereby.

In one example, the controller is configured to control parameters of the voltage supplied by the power supply to the terminal lens-electrode synchronously with: an ion mobility separation device located upstream of the first ion guide, for example a mobility scan thereof; and/or an orthogonal acceleration assembly of a TOF mass analyzer located downstream of the first ion guide, for example a TOF trigger of a pusher thereof.

In one example, the controller is configured to control, for example dynamically, ramp parameters of the voltage supplied by the power supply to the terminal lens-electrode, for example for the respective ions, such as according to the respective mass to charge ratios m/z and/or ion mobilities thereof, synchronously with: an ion mobility separation device located upstream of the first ion guide, for example a mobility scan thereof; and/or an orthogonal acceleration assembly of a TOF mass analyzer located downstream of the first ion guide, for example a TOF trigger of a pusher thereof; preferably wherein the ramp parameters are selected from a group consisting of ramp rate and a delay between a start of the ramp (for example, from high voltage to low voltage or vice versa) and a TOF trigger (i.e. the ramp start time, either absolute or relative to the TOF trigger).

In one example, the controller is configured to control the parameters of the voltage supplied by the power supply to the terminal lens-electrode, to select a mass to charge ratio m/z bandwidth (i.e. range) and/or a particular mass to charge ratio m/z to be acquired. In one example, the controller is configured to control ramp parameters of the voltage, to select a mass to charge ratio m/z bandwidth (i.e. range) and/or a particular mass to charge ratio m/z to be acquired. In one example, the controller is configured to control ramp rate and/or a delay between a start of the ramp and a TOF trigger (i.e. the ramp start time, either absolute or relative to the TOF trigger), to select a mass to charge ratio m/z bandwidth (i.e. range) and/or a particular mass to charge ratio m/z to be acquired. In one example, the controller is configured to control ramp rate to select a mass to charge ratio m/z bandwidth (i.e. range) to be acquired. In one example, the controller is configured to control a delay between a start of the ramp and a TOF trigger (i.e. the ramp start time, either absolute or relative to the TOF trigger) to select a particular mass to charge ratio m/z to be acquired.

In one example, the delay between a start of the ramp and a TOF trigger is in a range from 10 μs to 100 μs, preferably in a range from 20 μs to 80 μs, more preferably in a range from 30 μs to 60 μs.

In one example, the ramp rate is in a range from 1 V/μsec to 100 V/μsec, preferably in a range from 2 V/μsec to 50 V/μsec, more preferably in a range from 4 V/μsec to 25 V/μsec, most preferably in a range from 8 V/μsec to 16 V/μsec.

In one example, the controller is designed and configured to be operated such that ions exiting the radio-frequency ion guide reach the interface having specified ion beam conditions, for example for maximizing mass resolving power in a TOF mass analyzer.

### Ion Optical Assembly

In one example, the ion guide assembly comprises an ion optical assembly located downstream, for example downstream of the first ion guide, the set of electrodes and/or the terminal lens-electrode for guiding ions exiting the radio frequency ion guide, for example towards and/or to an ion optical assembly.

### Screening Lens-Electrode

In one example, the ion guide assembly comprises a screening lens-electrode located between the terminal lens-electrode and the ion optical assembly for substantially screening the ion optical assembly from the at least one voltage applied to the terminal lens-electrode.

### Interface

In one example, the ion guide assembly comprises an interface coupled to a mass analyzer located downstream, for example downstream of the first ion guide, the set of electrodes, the terminal lens-electrode, a screen lens-electrode and/or an ion optical assembly, for receiving the ions exiting from the exit of the first ion guide.

In one example, the controller is configured to control the parameters of the voltage supplied by the power supply to the terminal lens-electrode to determine the respective exit times of the ions exiting from the exit of the first ion guide such that the ions are received in the interface at respective times (sequentially, not all at the same time, but a particular m/z range).

In one example, the controller is configured to control the parameters of the voltage supplied by the power supply to the terminal lens-electrode to determine the respective exit times of the ions exiting from the exit of the first ion guide in accordance with the pusher, for example a timing thereof.

In one example, the interface comprises and/or is an orthogonal acceleration assembly of a TOF mass analyzer, comprising a pusher for out-pulsing (pushing) the received ions in a direction substantially perpendicular to a direction of receiving the ions.

In one example, the interface is an orthogonal acceleration assembly of a TOF mass analyzer for out-pulsing the received ions in a direction substantially perpendicular to a direction of receiving the ions.

In one example, the orthogonal acceleration assembly is coupled to at least one reflector for substantially reversing an ion's motion.

### Ion Mobility Separation Device

In one example, the ion guide assembly comprises an ion mobility separation device located upstream for providing the ions into the entrance of the first ion guide, wherein the ions comprise and/or are ion mobility separated ions.

In one example, wherein the controller is configured to control the parameters of the voltage supplied by the power supply to the terminal lens-electrode to determine the respective exit times of the ions exiting from the exit of the first ion guide based on respective mobilities of the ion mobility separated ions.

### MSⁿ

In one example, the controller is configured to control the parameters of the voltage supplied by the power supply to the terminal lens-electrode, dependent upon a mass spectrometry acquisition mode, for example a MSⁿ acquisition mode, wherein n is a natural number greater than or equal to 1, for example 1, 2, 3, 4, 5 or more. In one example, the controller is configured to control ramp parameters of the voltage, dependent upon a mass spectrometry acquisition mode, for example a MSⁿ acquisition mode, wherein n is a natural number greater than or equal to 1, for example 1, 2, 3, 4, 5 or more. In one example, the controller is configured to control ramp rate and/or a delay between a start of the ramp and a TOF trigger (i.e. the ramp start time, either absolute or relative to the TOF trigger), dependent upon a mass spectrometry acquisition mode, for example a MSⁿ acquisition mode, wherein n is a natural number greater than or equal to 1, for example 1, 2, 3, 4, 5 or more.

In one example, the controller is configured to selectively control ramp rate, dependent upon a mass spectrometry acquisition mode, for example a MSⁿ acquisition mode, wherein n is a natural number greater than or equal to 1, for example 1, 2, 3, 4, 5 or more, wherein the control ramp rate is relatively higher for n is equal to 1 and wherein the control ramp rate is relatively lower for n is greater than 1, or vice versa. In one example, a ratio between the respective ramp rates for n is equal to 1 and for n is greater than one is in a range from 11:10 to 10:1, preferably in a range from 3:2 to 5:1, more preferably in a range from 4:3 to 3:1, for example 2:1.

In one example, the controller is configured to selectively control a delay between a start of the ramp and a TOF trigger (i.e. the ramp start time, either absolute or relative to the TOF trigger), dependent upon a mass spectrometry acquisition mode, for example a MSⁿ acquisition mode, wherein n is a natural number greater than or equal to 1, for example 1, 2, 3, 4, 5 or more, wherein the delay is correlated with ion mobility and/or mass to charge ratio m/z, for example wherein respective delays are correlated with respective ion mobilities and/or respective mass to charge ratios m/z and wherein the respective delays for n is equal to 1 and for n is greater than 1 are mutually different, for example wherein the respective correlations of the delay with ion mobility for n is equal to 1 and for n is greater than 1 are mutually different.

In one example, the controller is configured to control ramp rate and a delay between a start of the scan (or ramp) and a TOF trigger (i.e. the ramp start time, either absolute or relative to the TOF trigger), for a MSⁿ acquisition mode, wherein n is equal to 1, wherein the ramp rate is relatively higher and/or wherein the delay is correlated with ion mobility and/or mass to charge ratio m/z, for example wherein respective delays are correlated with respective ion mobilities and/or respective mass to charge ratios m/z.

In one example, the controller is configured to control ramp rate and a delay between a start of the ramp and a TOF trigger (i.e. the ramp start time, either absolute or relative to the TOF trigger), for a MSⁿ acquisition mode, wherein n is greater than 1, for example wherein n is equal to 2, 3, 4, 5 or more, wherein the ramp rate is relatively lower and/or wherein the delay is correlated with ion mobility and/or mass to charge ratio m/z, for example wherein respective delays are correlated with respective ion mobilities and/or respective mass to charge ratios m/z.

### Exemplary Ion Guide Assemblies

In one example, the ion guide assembly comprises:
a first ion guide, having an entrance and an exit;
a set of electrodes, including a terminal lens-electrode disposed adjacent to the exit of the first ion guide;
a power supply, configured to supply voltages to the set of electrodes; and
a controller, configured to control the power supply to supply a voltage, for example an AC voltage, to the terminal lens-electrode to regulate exiting of ions from the exit of the first ion guide;
characterized by:
wherein the controller is configured to control parameters of the voltage supplied by the power supply to the terminal lens-electrode to determine respective exit times of the ions exiting from the exit of the first ion guide;
wherein the ion guide assembly further comprises:
an ion mobility separation device located upstream for providing the ions into the entrance of the first ion guide, wherein the ions comprise and/or are ion mobility separated ions; and
an interface coupled to a mass analyzer located downstream for receiving the ions exiting from the exit of the first ion guide, wherein the interface comprises and/or is an orthogonal acceleration assembly of a TOF mass analyzer, comprising a pusher for out-pulsing (pushing) the received ions in a direction substantially perpendicular to a direction of receiving the ions;
wherein the controller is configured to:
control the ramp rate (i.e. scan rate) of the voltage supplied by the power supply to the terminal lens-electrode to determine respective exit times of the ions exiting from the exit of the first ion guide based on respective mobilities of the ion mobility separated ions such that the ions are received in the interface at respective times in accordance with the pusher, for example a timing thereof.

In one example, the ion guide assembly comprises
an ion mobility separation device configured to separate ions based on mobility;
a first ion guide, having an entrance and an exit;
a set of electrodes, including a terminal lens-electrode disposed adjacent to the exit of the first ion guide;
an orthogonal acceleration assembly of a TOF mass analyzer, comprising a pusher;
a power supply, configured to supply voltages to the set of electrodes; and
a controller, configured to control the power supply to supply a voltage, for example an AC voltage, to the terminal lens-electrode to regulate exiting of ion mobility separated ions from the exit of the first ion guide into the orthogonal acceleration assembly;
characterized by:
wherein the controller is configured to control parameters of the voltage supplied by the power supply to the terminal lens-electrode to determine respective exit times of the ion mobility separated ions exiting from the exit of the first ion guide in accordance with the pusher.

In one example, the at least one voltage comprises an alternating current voltage which is instrumental in generating a mass dependent pseudo-potential reaching into the radio frequency ion guide through its exit end.

In one example, the pseudo-potential is designed and configured to cause a stratification of ions along an axis of the radio frequency ion guide near the exit end of the radio frequency ion guide during the first phase of operation, ions of larger mass to charge ratio being held closer to the terminal lens-electrode and ions of a smaller mass to charge ratio being held further away from the terminal lens-electrode.

In one example, an amplitude of the alternating current voltage is ramped down according to a predetermined time profile during the second phase of operation.

In one example, an amplitude of a voltage applied to the screening lens electrode is changed synchronously with the ramping down of the alternating current voltage.

In one example, a DC gradient applied across the radio frequency ion guide is changed synchronously with the ramping down of the alternating current voltage.

In one example, the at least one voltage comprises a direct current bias voltage.

In one example, the screening lens-electrode is skimmer-shaped with the apex pointing towards the terminal lens-electrode.

In one example, the ion optical assembly comprises a plurality of electrodes each being skimmer-shaped with apexes pointing towards the terminal lens-electrode.

In one example, the radio frequency ion guide, the terminal lens-electrode, the screening lens-electrode, the ion optical assembly and the interface share a common axis.

In one example, the assembly comprises an electronic circuit for generating a direct current voltage gradient between the exit end of the radio frequency ion guide and the interface.

In one example, the assembly comprises an electronic circuit for generating a direct current voltage gradient inside the radio frequency ion guide for propelling the ions towards the exit end of the ion guide.

In one example, the at least one voltage comprises and/or is a trapping voltage during the first phase of operation. In one example, a duration of the first phase is in a range from 50 μs to 500 μs, preferably in a range from 100 μs to 250 μs, for example at most 200 μs.

In one example, an amplitude of the AC voltage is increased, for example pulsed, from near zero to a maximum amplitude and then maintained constant, for example for a duration of the first phase, during the first phase of operation.

In one example, an amplitude of the AC voltage is decreased, for example ramped down such as ramped down non-linearly, from the maximum amplitude to a minimum amplitude or to zero over a predetermined period, for example over a duration of the second phase, during the second phase of operation. In one example, the non-linear ramp comprises and/or is an S-shaped curve or a curve where the first derivative of the voltage change over time is negative and/or the second derivative is negative.

In one example, at least one voltage comprises and/or is an ejection voltage during the second phase of operation. In one example, a duration of the second phase is in a range from 10 μs to 250 μs, preferably in a range from 20 μs to 100 μs, for example at most 50 μs.

In one example, a frequency of the alternating current voltage is in a range from 10 KHz to 10 MHz, preferably in a range from 300 kHz to 3 MHz.

In one example, a spacing between the terminal lens-electrode and the screening lens-electrode, for example an apex thereof and/or between respective apexes, is in a range from 0.1 mm to 5.0 mm, preferably in a range from 0.25 mm to 2.5 mm, more preferably in a range from 0.5 mm to 2.0 mm, most preferably in a range from 0.75 mm to 1.5 mm, for example 1.0 mm.

In one example, a size of the aperture of the screening lens-electrode is equivalent (for example, about the same or the same) to a size of the aperture of the terminal lens electrode.

In one example, a spatial spread, for example an axial spread and/or a radial spread, of the ions, for example after the screening lens-electrode, is at most 3 mm, preferably at most 2 mm, more preferably at most 1 mm (FWHM), for example in the TOF direction.

In one example, a radial energy spread of the ions, for example after the screening lens-electrode, is at most 75 meV, preferably at most 50 meV, more preferably at most 25 meV (FWHM).

In one example, an axial energy spread of the ions, for example after the screening lens-electrode, is at most 10 eV, preferably at most 5 eV, more preferably at most 2 eV (FWHM).

In one example, a m/z range of the ions is 50 Da to 10,000 Da, preferably 100 Da to 5,000 Da, more preferably 200 Da to 2,500 Da.

### Method of Guiding Ions

The second aspect provides a method of guiding ions, the method comprising:
guiding ions in a first ion guide, having an entrance and an exit; and
regulating exiting of ions from the exit of the first ion guide by controlling supply of a voltage, for example an AC voltage, to a terminal lens-electrode disposed adjacent to the exit of the first ion guide;
characterized by:
controlling parameters of the voltage supplied to the terminal lens-electrode to determine respective exit times of the ions exiting from the exit of the first ion guide.

The second aspect may include any step described with respect to the first aspect mutatis mutandis.

In one example, controlling the parameters of the voltage supplied to the terminal lens-electrode to determine the respective exit times of the ions exiting from the exit of the first ion guide comprises controlling ramp amplitude, ramp duration, ramp start time, ramp end time, ramp rate, ramp shape and/or ramp direction of the voltage supplied to the terminal lens-electrode to determine the respective exit times of the ions exiting from the exit of the first ion guide.

In one example, the method comprises ion mobility separating ions upstream of the first ion guide, wherein the ions comprise and/or are ion mobility separated ions.

In one example, the method comprises out-pulsing the ions into a mass analyzer located downstream of the first ion guide, in a direction substantially perpendicular to a direction of receiving the ions.

In one example, controlling the parameters of the voltage supplied to the terminal lens-electrode to determine the respective exit times of the ions exiting from the exit of the first ion guide comprises controlling, for example dynamically, ramp parameters of the voltage supplied by the power supply to the terminal lens-electrode, for example for the respective ions, such as according to the respective mass to charge ratios m/z and/or ion mobilities thereof, synchronously with: an ion mobility separation device located upstream of the first ion guide, for example a mobility scan thereof; and/or an orthogonal acceleration assembly of a TOF mass analyzer located downstream of the first ion guide, for example a TOF trigger of a pusher thereof; preferably wherein the ramp parameters are selected from a group consisting of ramp rate and a delay between a start of the ramp (for example, from high voltage to low voltage or vice versa) and a TOF trigger (i.e. the ramp start time, either absolute or relative to the TOF trigger).

### Assembly for Mass Spectrometry

A third aspect provides an assembly for mass spectrometry, comprising:
an ion mobility separation device configured to separate ions based on mobility;
a radio frequency ion guide for receiving the ion mobility separated ions through an entrance end, holding the ion mobility separated ions within and outputting the ion mobility separated ions through an exit end;
a terminal lens-electrode located at the exit end of the radio frequency ion guide, being connected to a power source for, during a first phase of operation, receiving at least one voltage which keeps the ion mobility separated ions from exiting the radio frequency ion guide through the exit end and, during a second phase of operation, changing the at least one voltage received by the terminal lens-electrode so as to allow the ion mobility separated ions of a selected mass to charge ratios m/z to exit the radio frequency ion guide through the exit end sequentially;
an ion optical assembly located downstream of the terminal lens-electrode for guiding the ion mobility separated ions of the selected mass to charge ratios m/z exiting the radio frequency ion guide;
a screening lens-electrode located between the terminal lens-electrode and the ion optical assembly for substantially screening the ion optical assembly from the at least one voltage applied to the terminal lens-electrode;
an interface coupled to an orthogonal mass analyzer located downstream from the ion optical assembly for receiving the ion mobility separated ions of the selected mass to charge ratios m/z exiting from the radio frequency ion guide;
a control system communicating with the terminal lens-electrode and the interface and being designed and configured such that the changing the at least one voltage is executed such that substantially all the ion mobility separated ions of a selected mass to charge ratio m/z exiting from the radio frequency ion guide are out-pulsed therefrom at substantially the same time into the orthogonal mass analyzer.

The assembly according to the third aspect may include any feature described with respect to the first aspect and/or implement any step described with respect to the second aspect mutatis mutandis.

### Method of Mass Spectrometry

The fourth aspect provides a method of mass spectrometry, comprising:
separating ions based on mobility;
receiving the ion mobility separated ions through an entrance end in a radio frequency ion guide, holding the ion mobility separated ions within the radio frequency ion guide and outputting the ion mobility separated ions through an exit end of the radio frequency ion guide, comprising: during a first phase of operation, receiving at least one voltage, at a terminal lens-electrode located at the exit end of the radio frequency ion guide, which keeps the ion mobility separated ions from exiting the radio frequency ion guide through the exit end; and during a second phase of operation, changing the at least one voltage received by the terminal lens-electrode so as to allow the ion mobility separated ions of selected mass to charge ratios m/z to exit the radio frequency ion guide through the exit end sequentially;
guiding the ion mobility separated ions of the selected mass to charge ratios m/z exiting the radio frequency ion guide in an ion optical assembly located downstream of the terminal lens-electrode;
substantially screening the ion optical assembly from the at least one voltage applied to the terminal lens-electrode using a screening lens-electrode located between the terminal lens-electrode and the ion optical assembly;
receiving the ion mobility separated ions of the selected mass to charge ratios m/z exiting from the radio frequency ion guide in an interface coupled to an orthogonal mass analyzer located downstream from the ion optical assembly; and
controlling the terminal lens-electrode and the interface such that the changing the at least one voltage is executed such that substantially all the ion mobility separated ions of a selected mass to charge ratio m/z exiting from the radio frequency ion guide are out-pulsed therefrom at substantially the same time into the orthogonal mass analyzer.

The method according to the fourth aspect may include any step described with respect to the first aspect, the second aspect and/or the third aspect mutatis mutandis.

### Mass Spectrometer and Method

The fifth aspect provides a mass spectrometer comprising an ion guide assembly according to the first aspect; and/or an assembly according to the third aspect.

The sixth aspect provides a method of guiding ions according to the second aspect; and/or a method of mass spectrometry according to the third aspect.

The exemplary embodiments of the invention are further described below with reference to the drawings.

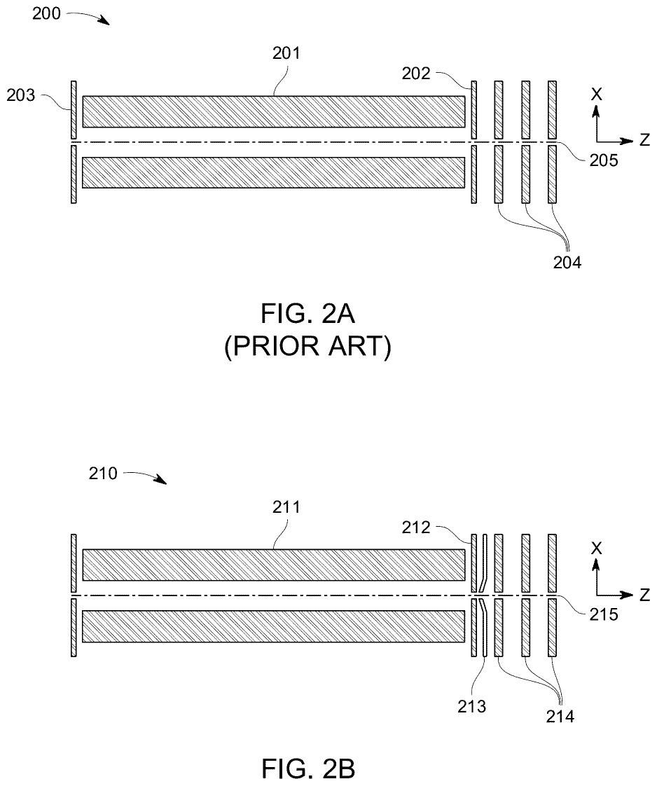

FIG. 2 shows a cross section of a standard quadrupole ion guide operated as a collision cell 200 comprising a pair of pole-electrodes 201 and equipped with a DC terminal lens electrode 202 switched between a trapping voltage level and an ejection voltage level. Ions are injected through an aperture on electrode 203 disposed at the entrance end of the collision cell and transferred along the z axis 205 of the device. Parent ions and product or fragment species ejected through the aperture on the terminal lens electrode 202 disposed at the exit end of the collision cell are collimated by a set of electrostatic lenses, the ion optical assembly 204, to achieve high mass resolving power in the TOF.

FIG. 2 also shows a cross section of the new quadrupole ion guide disclosed in the present invention and operated as a collision cell 210 comprising a pair of pole-electrodes 211 and equipped with a DC terminal lens electrode 212 supplied with an additional AC signal. A new screening lens-electrode electrode 213 is positioned immediately after the terminal lens electrode 211 to confine the alternating field produced by the AC voltage. Practically, the screening lens-electrode prevents the corresponding AC field from penetrating into the ion optical assembly 214 used for collimating the ions along the ion optical path 215 of the device (z axis).

To minimize penetration of the AC field into the set of electrostatic lenses and/or to minimize capacitive coupling of the AC to the screening lens-electrode, the screening lens-electrode 213 is skimmer-shaped with the apex of the skimmer positioned 1 mm from the terminal lens electrode 212. In this example, the size of the aperture on the screening lens-electrode 213 is equivalent to the aperture on the terminal lens electrode 212. This arrangement confines the AC field in a narrow space established between the extraction 212 and the screen 213 lens electrodes.

This narrow gap also minimizes the residence time of the ions in the AC field outside of the collision cell 210 where the RF voltage applied to the pole-electrodes 211 can no longer radially confine the ions (x axis). As a result, the AC field extending beyond the terminal lens electrode 212 can no longer affect the properties of the ion beam during ejection. Ion beam parameters such as radial energy spread (δEx) resulting in beam divergence, spatial spread (δx) as well as the axial kinetic energy spread (δEz) remain unaffected. By conserving the beam parameters in the new geometry disclosed in the present invention, the performance of the TOF mass analyzer is equivalent to the standard geometry 200. Hence, the new geometry reduces the complexity of the electronics required to operate the system without affecting the quality of the ion beam, thus enabling high resolution high mass accuracy TOF measurements to be performed seamlessly.

Indeed, both simulations and experimental data have confirmed the advantage of the new design over prior art where the application of the AC lens leads to a deterioration in TOF performance when the AC voltage is applied to the terminal lens electrode.

The specified ion beam conditions involve the kinetic energy and spatial characteristics of an ion beam introduced into the TOF analyzer to achieve high mass resolving power. The specified ion beam conditions may include the spatial spread of the incoming ion beam in the direction of the TOF, the radial kinetic energy spread, and the axial kinetic energy spread. Designing ion optics to control these parameters is important in high performance TOF MS, hence the need to specify the ion beam conditions a priori. For example, a specified set of ion beam parameters may involve maintaining the spatial spread of the ions to <1 mm (FWHM) in the TOF direction, the radial energy spread to <25 meV (FWHM) and the axial energy spread to <2 eV (FWHM). Narrow radial energy spreads reduce beam divergence and minimizes the spatial spread of the ions at the point of extraction in the TOF, while narrow axial energy spreads are important for minimizing the axial spread of the ions during flight time, thus enhancing sensitivity by improving the number of ions hitting the detector surface.

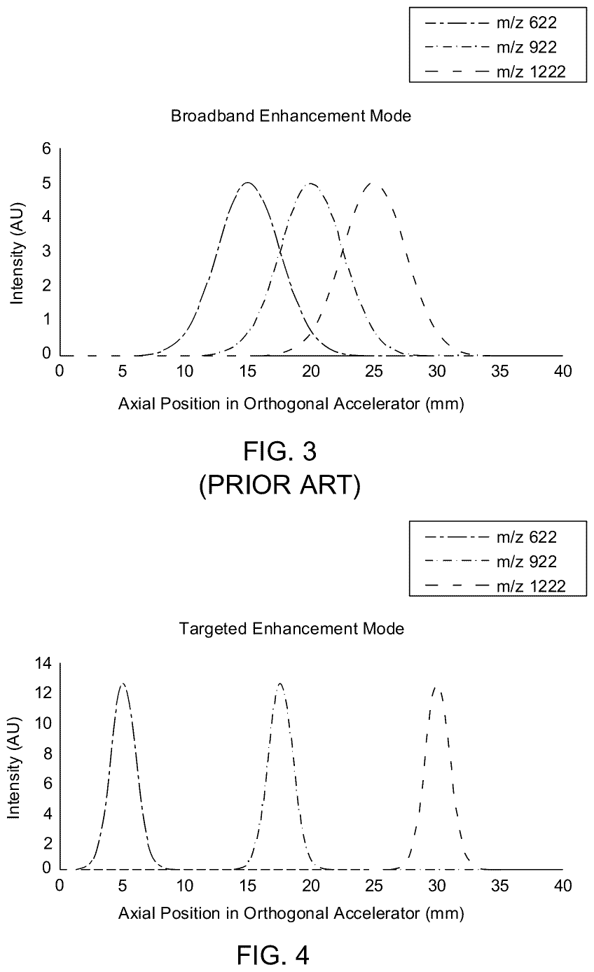

FIG. 3 is a graph of intensity versus axial position in orthogonal accelerator for a conventional method.

A moderate AC ramp down rate is used to time focus ions of different m/z to the orthogonal accelerator.

It has been found a slower AC ramp rate gives better spatial overlap of the m/z range, but at the expense of overall signal intensity as more of the signal falls outside the OA/Detector acceptance area.

FIG. 4 is a graph of intensity versus axial position in orthogonal accelerator for a method according to an exemplary embodiment.

A much higher AC ramp down rate is used, this results in shaper peaks (note the intensity difference, AUC is maintained between FIGS. 3 and 4), but with a reduced mass bandwidth.

As the TIMS ramp occurs, the m/z distribution shifts absolute positions in the OA with the mobility scan. Hence, by adjusting the delay of the ramp, the absolute position of a given m/z in the OA may be adjusted.

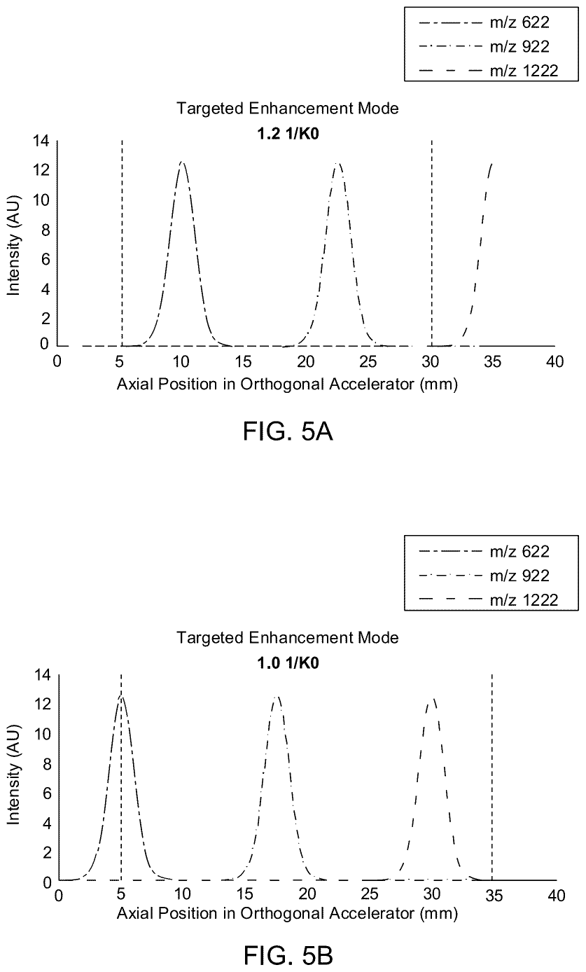

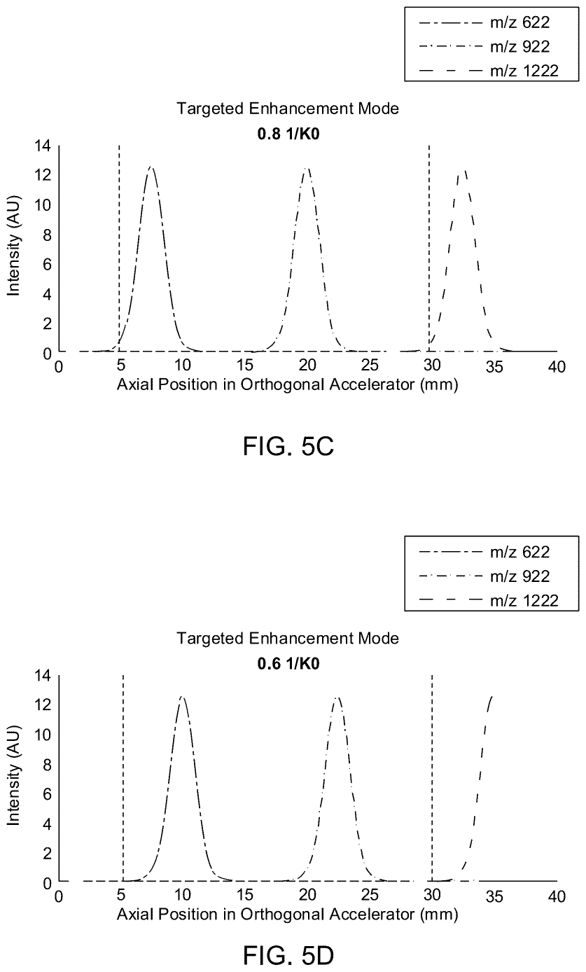

This is exemplified further in FIGS. 5A to 5D.

FIGS. 5A to 5D are graphs of intensity versus axial position in orthogonal accelerator for a method according to an exemplary embodiment: FIG. 5A: 1.2 1/K0; FIG. 5B: 1.0 1/K0; FIG. 5C: 0.8 1/K0; and FIG. 5D: 0.6 1/K0.

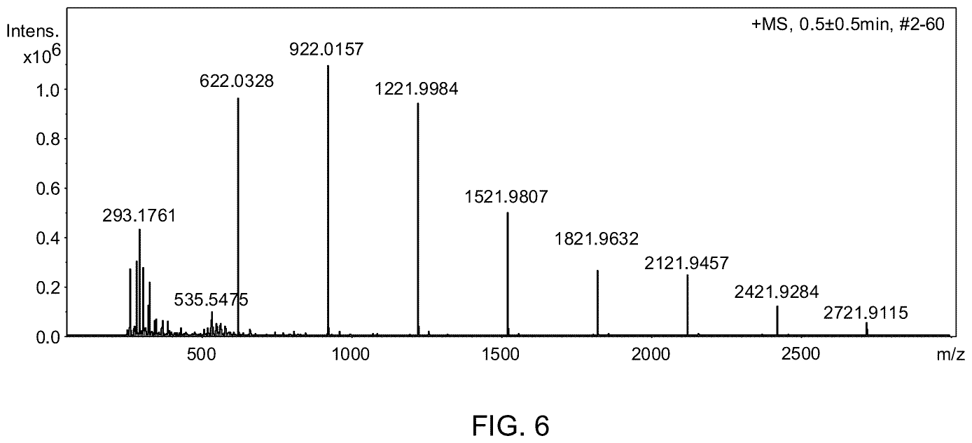

FIG. 6 is a graph of intensity versus m/z for a method for a conventional method: a normal tune mix distribution, using standard collision cell operation (2000 Vpp 10 μsec prepulse 120 μsec transfer).

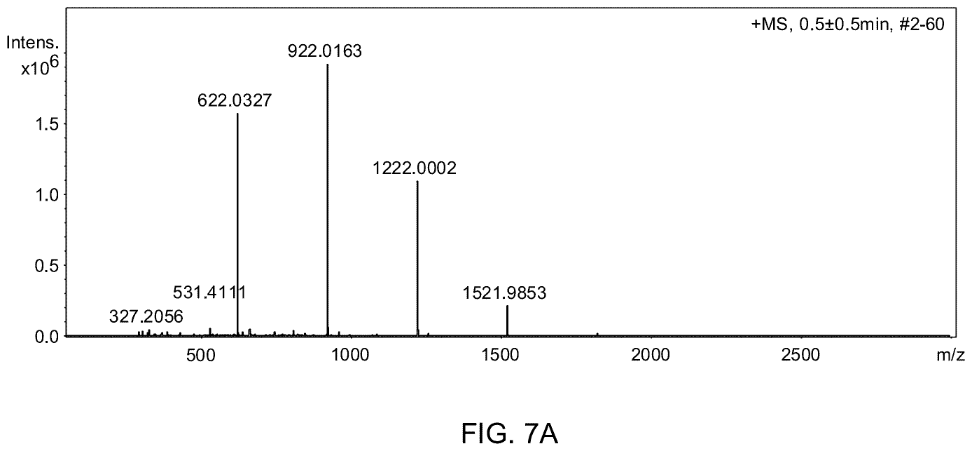

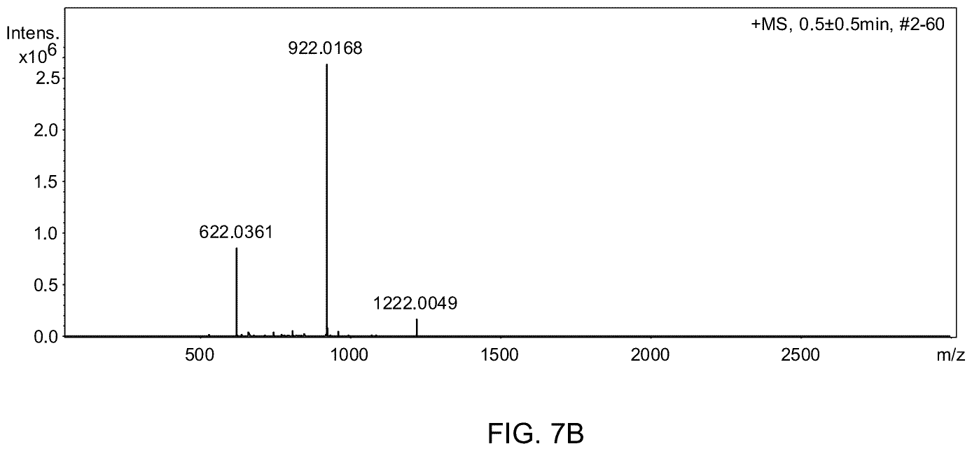

FIGS. 7A to 7B are graphs of intensity versus m/z for a method according to an exemplary embodiment: FIG. 7A shows using a 60 μsec delay and a scan of 70 μsec (8 V/μsec), the m/z range is reduced but intensity for transmitted species increased; and FIG. 7B shows using a 92 μsec delay and scan time 35 μsec (16 V/μsec), the m/z bandwidth is further reduced with signal increasing for the transmitted range. Collision cell operation otherwise as for FIG. 6.

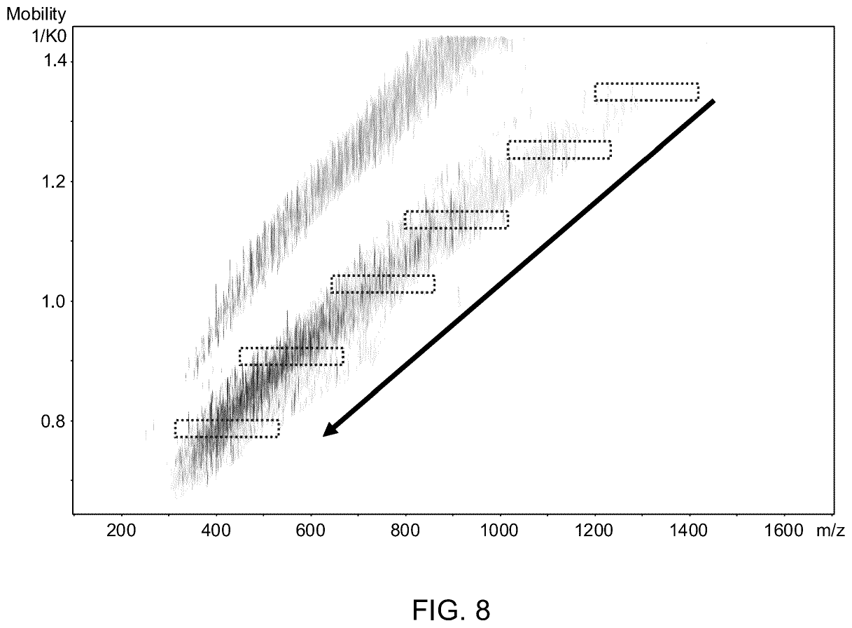

FIG. 8 is a plot of mobility versus m/z for a method according to an exemplary embodiment, showing moving survey scan targeted enhancement area.

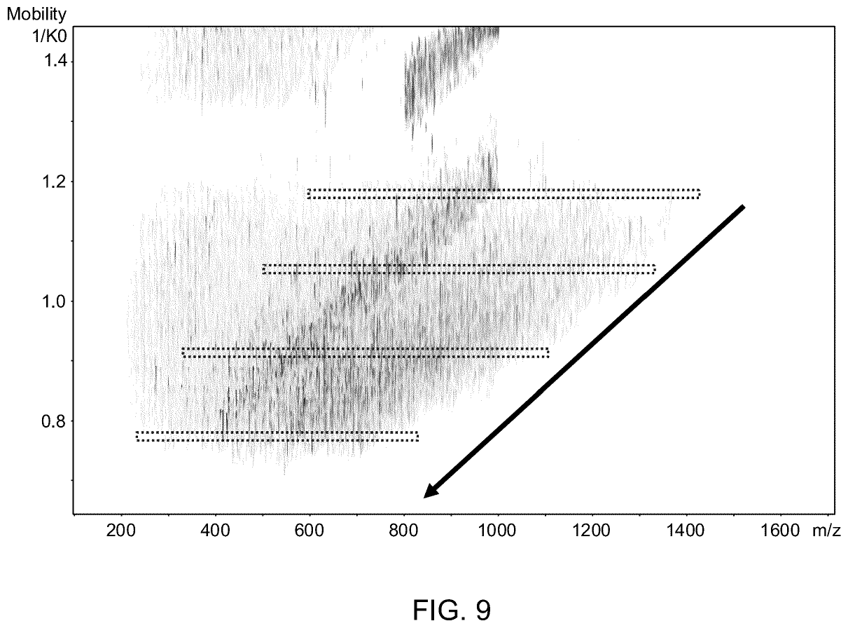

FIG. 9 is a plot of mobility versus m/z for a method according to an exemplary embodiment, showing moving fragment scan targeted enhancement area.

FIGS. 8 and 9 are examples of the targeted enhancement regions for survey and fragment TIMS-MS scans, respectively. In other examples, the mass bandwidth may be even narrower.

A 2× to 3× signal enhancement is provided by the exemplary methods by switching to a faster AC ramp, compared with conventional broadband AC mode, which in turn already provides a signal enhancement of 2× to 3× over trap pulse alone.

Operating in TIMS mode and targeting a known mobility, mass trendline, for example 2+ peptides, in MS1 mode (also known as MS mode) would enable further signal enhancement as ions outside this trend line are not of interest.

The same enhancement can be targeted in MS2 mode (also known as MS/MS mode), albeit with lower enhancement factors due to the higher mass bandwidth requirements.

The distribution is quite narrow in MS, but much less so in MS/MS, but there is still a trend of mobility and fragment mass that may be exploited, for example by adjusting the delay of the AC ramp, the ramp rate or both the delay of the AC ramp and the ramp rate to maximize signal especially at the high mobility end of the scan.

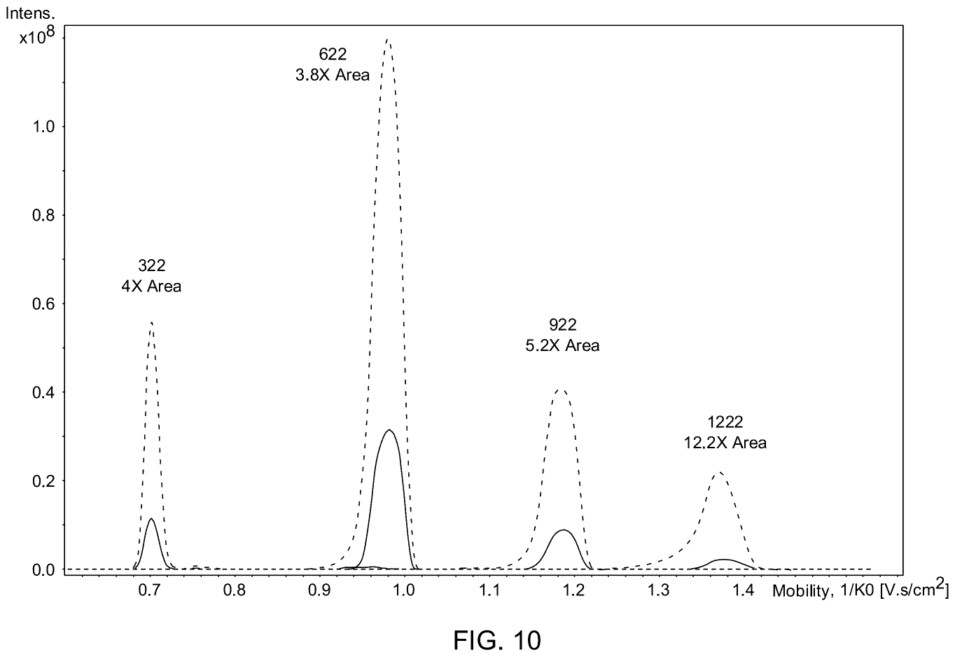

FIG. 10 is a graph of intensity versus mobility of ions for: (a) a conventional method (black line); and (b) a method according to an exemplary embodiment (blue line).
Trap-Pulse 12.5 μs PPS 60 μs Transfer
675-0 Vpp in 55 μs i.e. 12.3 V/μs
Mobility Range 1.55-0.6 1/K0
100 ms ramp, 10 ms fill
Start Delay 32 μs, stepped 22 ns/TOF

Linear shift in delay, calculated from static optimums, is shown in Table 1.

TABLE 1
Linear shift in delay, calculated from static optimums.

| m/z | Delay (μs) |
|---|---|
| 118 | 58 |
| 322 | 54 |
| 622 | 48 |
| 922 | 44 |
| 1222 | 40 |
| 1522 | 38 |

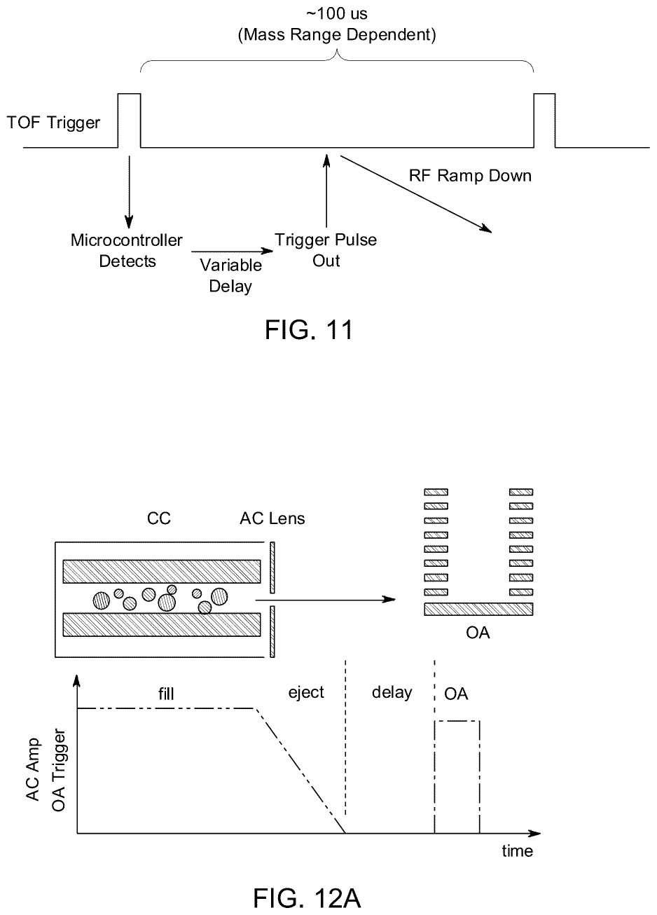

FIG. 11 schematically depicts a method according to an exemplary embodiment.

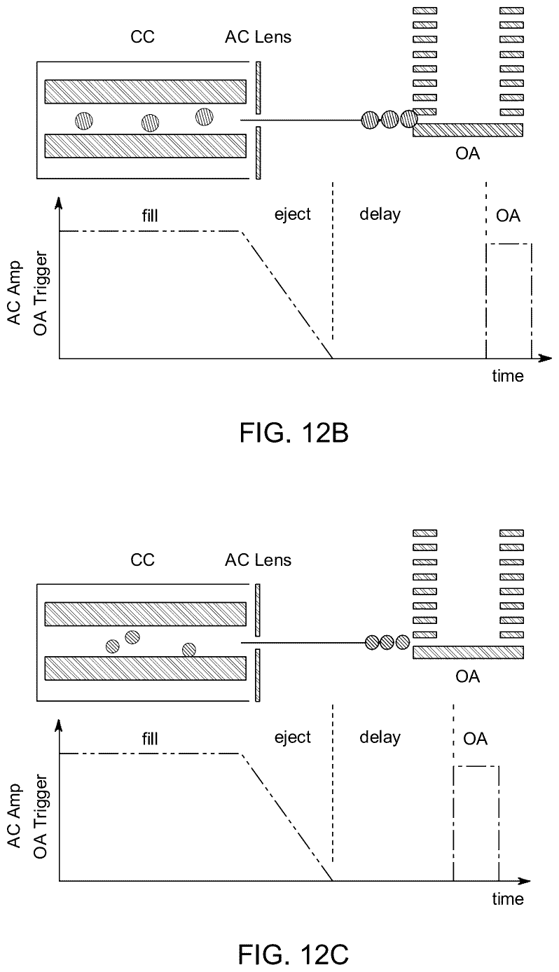

FIGS. 12A to 12C schematically depict a method according to an exemplary embodiment.

FIG. 12A schematically depicts analysis of ions without ion mobility separation.

The AC lens is at the exit of the collision cell. There is an accumulation period, ion ejection, and a delay to the pulse of the orthogonal accelerator.

During accumulation the AC amplitude is held at a high potential to trap ions in the CC. During ejection the AC amplitude is ramped down.

FIGS. 12B and 12C schematically depict analysis of ions with ion mobility separation.

Particularly, the delay is progressively reduced from FIG. 12B to FIG. 12C, for example during an ion mobility scan. The delay to the OA pulse is dependent on the m/z range of interest, which is correlated with ion mobility. High m/z ions are slower getting to the OA so the delay is set to a relatively longer time.

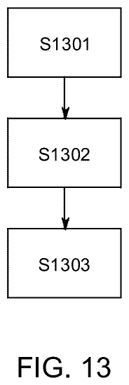

FIG. 13 schematically depicts a method according to an exemplary embodiment.

The method of guiding ions comprises:
guiding ions in a first ion guide, having an entrance and an exit (S1201);
regulating exiting of ions from the exit of the first ion guide by controlling supply of a voltage, for example an AC voltage, to a terminal lens-electrode disposed adjacent to the exit of the first ion guide (S1202);
characterized by:
controlling parameters of the voltage supplied to the terminal lens-electrode to determine respective exit times of the ions exiting from the exit of the first ion guide (S1203).

1. An ion guide assembly, comprising:
a first ion guide, having an entrance and an exit;
a set of electrodes, including a terminal lens-electrode disposed adjacent to the exit of the first ion guide;
a power supply, configured to supply voltages to the set of electrodes; and
a controller, configured to control the power supply to supply a voltage to the terminal lens-electrode to regulate exiting of ions from the exit of the first ion guide;
wherein the controller is configured to control ramp parameters of the voltage supplied by the power supply to the terminal lens-electrode to determine respective exit times of the ions exiting from the exit of the first ion guide; and
wherein the ramp parameters are selected from a group consisting of ramp amplitude, ramp duration, ramp start time, ramp end time, ramp rate, ramp shape and/or ramp direction.

2. The ion guide assembly according to claim 1, wherein the controller is configured to dynamically control the ramp parameters of the voltage supplied by the power supply to the terminal lens-electrode.

3. The ion guide assembly according to claim 1, further comprising an interface coupled to a mass analyzer located downstream for receiving the ions exiting from the exit of the first ion guide; wherein the controller is configured to control the ramp parameters of the voltage supplied by the power supply to the terminal lens-electrode to determine the respective exit times of the ions exiting from the exit of the first ion guide such that the ions are received in the interface at respective times.

4. The ion guide assembly according to claim 3, wherein the interface comprises and/or is an orthogonal acceleration assembly of a TOF mass analyzer, comprising a pusher for out-pulsing (pushing) the received ions in a direction substantially perpendicular to a direction of receiving the ions; and wherein the controller is configured to control the parameters of the voltage supplied by the power supply to the terminal lens-electrode to determine the respective exit times of the ions exiting from the exit of the first ion guide in accordance with the pusher.

5. The ion guide assembly according to claim 1, further comprising an ion mobility separation device located upstream for providing the ions into the entrance of the first ion guide, wherein the ions comprise and/or are ion mobility separated ions.

6. The ion guide assembly according to claim 5, wherein the controller is configured to control the parameters of the voltage supplied by the power supply to the terminal lens-electrode to determine the respective exit times of the ions exiting from the exit of the first ion guide based on respective mobilities of the ion mobility separated ions.

7. The ion guide assembly according to claim 1, wherein the controller is configured to control the ramp parameters of the voltage supplied by the power supply to the terminal lens-electrode, to select a mass to charge ratio m/z bandwidth and/or a particular mass to charge ratio m/z to be acquired.

8. The ion guide assembly according to claim 7, wherein the controller is configured to control ramp rate to select a mass to charge ratio m/z bandwidth to be acquired.

9. The ion guide assembly according to claim 7, wherein the controller is configured to control a delay between a start of the ramp and a TOF trigger to select a particular mass to charge ratio m/z to be acquired.

10. The ion guide assembly according to claim 1, wherein the controller is configured to control the ramp parameters of the voltage, dependent upon a mass spectrometry acquisition mode.

11. The ion guide assembly according to claim 10, wherein the controller is configured to control ramp rate and/or a delay between a start of the ramp and a TOF trigger, dependent upon a mass spectrometry acquisition mode.

12. The ion guide assembly according to claim 11, wherein the controller is configured to selectively control ramp rate, dependent upon a MSⁿ acquisition mode, where n is a natural number greater than or equal to 1.

13. The ion guide assembly according to claim 12, wherein a ratio between the respective ramp rates for n is equal to 1 and for n is greater than one is in a range from 11:10 to 10:1.

14. The ion guide assembly according to claim 10, wherein the controller is configured to selectively control a delay between a start of the ramp and a TOF trigger, dependent upon a mass spectrometry acquisition mode, wherein the delay is correlated with ion mobility and/or mass to charge ratio m/z.

15. A method of guiding ions, the method comprising:
guiding ions in a first ion guide, having an entrance and an exit;
regulating exiting of ions from the exit of the first ion guide by controlling supply of a voltage to a terminal lens-electrode disposed adjacent to the exit of the first ion guide; and
controlling ramp parameters of the voltage supplied to the terminal lens-electrode to determine respective exit times of the ions exiting from the exit of the first ion guide, the ramp parameters comprising ramp amplitude, ramp duration, ramp start time, ramp end time, ramp rate, ramp shape and/or ramp direction of the voltage supplied to the terminal lens-electrode.

16. The method according to claim 15, wherein controlling the ramp parameters of the voltage supplied to the terminal lens-electrode to determine the respective exit times of the ions exiting from the exit of the first ion guide further comprises controlling the ramp parameters of the voltage supplied by the power supply to the terminal lens-electrode, dependent upon a mass spectrometry acquisition mode.

17. The method according to claim 15, further comprising ion mobility separating ions upstream of the first ion guide, wherein the ions comprise and/or are ion mobility separated ions.

18. The method according to claim 15, further comprising out-pulsing the ions into a mass analyzer located downstream of the first ion guide, in a direction substantially perpendicular to a direction of receiving the ions.

19. The method according to claim 15, wherein controlling the parameters of the voltage supplied to the terminal lens-electrode to determine the respective exit times of the ions exiting from the exit of the first ion guide further comprises controlling ramp parameters of the voltage supplied by the power supply to the terminal lens-electrode synchronously with an ion mobility separation device located upstream of the first ion guide; and/or an orthogonal acceleration assembly of a TOF mass analyzer located downstream of the first ion guide.

20. An ion guide assembly, comprising:
a first ion guide, having an entrance and an exit;
a set of electrodes, including a terminal lens-electrode disposed adjacent to the exit of the first ion guide;
a power supply, configured to supply voltages to the set of electrodes; and
a controller, configured to control the power supply to supply a voltage to the terminal lens-electrode to regulate exiting of ions from the exit of the first ion guide;
wherein the controller is configured to control parameters of the voltage supplied by the power supply to the terminal lens-electrode to determine respective exit times of the ions exiting from the exit of the first ion guide;
wherein the ion guide assembly further comprises:
an ion mobility separation device located upstream for providing the ions into the entrance of the first ion guide, wherein the ions comprise and/or are ion mobility separated ions; and
an interface coupled to a mass analyzer located downstream for receiving the ions exiting from the exit of the first ion guide, wherein the interface comprises and/or is an orthogonal acceleration assembly of a TOF mass analyzer, comprising a pusher for out-pulsing (pushing) the received ions in a direction substantially perpendicular to a direction of receiving the ions; and
wherein the controller is configured to control the ramp rate (i.e. scan rate) of the voltage supplied by the power supply to the terminal lens-electrode to determine respective exit times of the ions exiting from the exit of the first ion guide based on respective mobilities of the ion mobility separated ions such that the ions are received in the interface at respective times in accordance with the pusher.
